(19) United States
(12) Patent Application Publication
(10) Pub. No.: US 2012/0128415 A1
(43) Pub. Date: May 24, 2012

(54) JOINT STRUCTURE

(75) Inventor: Kenta Hatano, Tokyo (JP)

(73) Assignee: Mitsubishi Electric Corporation, Tokyo (JP)

(21) Appl. No.: 13/388,655

(22) PCT Filed: Nov. 13, 2009
(86) PCT No.: PCT/JP2009/006083

§ 371 Date: Feb. 2, 2012

(51) Int. Cl. F16B 5/04

(52) U.S. Cl. 403/360

(57) ABSTRACT

A connecting structure includes a pin 32 which has a shoulder 32c adapted such that the diameter of a portion 32a to be fitted to a link plate 31 is formed larger than that of a portion 32b to be fitted to a joint 30 or a lever 2, and of which the tip portion 32d passing through a hole of the joint or lever is fixed by riveting, and a washer 33 that is disposed between the joint or lever fitted with the pin, and the link plate, and that is pressed and fixed against the joint or lever by the shoulder of the pin when the tip portion of the pin is riveted.

### TECHNICAL FIELD

The present invention relates to a connecting structure for connecting a joint fixed to an output shaft of an actuator and a lever on the part serving as an object to be actuated to each other through a link plate, for example.

### BACKGROUND ART

In a conventional connecting structure for connecting a joint fixed to an output shaft of an actuator and a lever to each other through a link plate, one end part of a joint pin is first passed through a hole formed through the end portion of a joint, and the tip portion of the joint pin projecting from the joint is fixed by riveting. Similarly, one end part of a lever pin is passed through a hole formed at the end portion of a lever, and the tip portion thereof is fixed by riveting. Then, a link plate for connecting the output shaft of the actuator and the lever to each other is fitted to the other end side of the joint pin and lever pin. Then, a retaining ring is fitted to the joint pin and lever pin fitted with the link plate to thus connect the output shaft of the actuator and the lever to each other (for example, see Patent Document 1).

### PRIOR ART DOCUMENTS

### Patent Documents

Patent Document 1: Japanese Unexamined Utility Model Publication No. 40355/1993

### SUMMARY OF THE INVENTION

However, in the conventional connecting structure disclosed in Patent Document 1, both of the joint pin and lever pin are arranged with the retaining rings, and thus when the actuator is driven to slide the link plate, application of load, wear, and so on are produced with the retaining ring. Therefore, there is a problem such that the deformation and damage of the retaining ring can be caused.

Moreover, in assembling the connecting structure, while the positions of the joint pin and lever pin fixed to the joint are adjusted, the link plate is fitted thereto, and further the retaining ring must be fitted thereto from above the link plate. Therefore, there is also a problem such that the assembly work must be done at much expense in time and effort.

The present invention is made to solve the above-mentioned problems, and an object of the invention is to provide a connecting structure such that the durability of a sliding portion of the structure can be enhanced, where a joint fixed to an output shaft of an actuator and a lever on the part serving as an object to be actuated are connected to each other through a link plate, and that the assembly work can be easily carried out.

A connecting structure of the invention includes: a pin which has a shoulder adapted such that the diameter of a portion to be fitted to a link plate is formed larger than that of a portion to be fitted to a joint or a lever, and of which the tip portion thereof passing through a hole of the joint or lever is fixed by riveting; and a washer which is disposed between the joint or lever fitted with the pin, and the link plate, and which is pressed against the joint or lever by the shoulder of the pin to be fixed, when the tip portion of the pin is riveted.

According to the invention, since it is arranged as discussed above, the pin passing through the link plate and fitted with the washer is passed through one of the joint and the lever to be fixed by riveting; thus, the durability to the sliding portion of the connecting structure can be increased, and further the assembly work of the connecting structure can be simplified.

### BRIEF DESCRIPTION OF THE DRAWINGS

FIG. 1 is a longitudinal sectional view of an actuator to which a connecting structure of a first embodiment in the present invention is applied.

FIG. 2 is a longitudinal sectional view taken along line A-A of FIG. 1 showing the connecting structure of the first embodiment in the invention.

### BEST MODE FOR CARRYING OUT THE INVENTION

In the following, embodiments of the present invention will be described in detail with reference to the accompanying drawings.

### First Embodiment

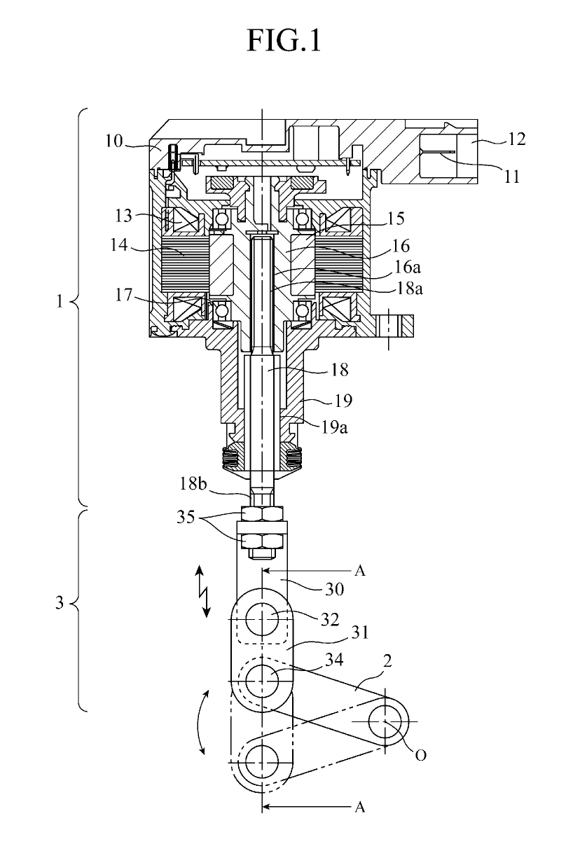

In an actuator 1 to which a connecting structure 3 of a first embodiment in the present invention is applied, as shown in FIG. 1, an external input-output connector 12 having a terminal 11 to which a voltage is applied is provided at the upper part of a housing 10. Also, a stator 14 having a plurality of poles and wound with a coil 13 is provided inside the housing 10. The stator 14 is NS magnetized in such a manner that when a voltage is applied to the terminal 11, a current is flown through the coil 13. Also, a rotor 16 equipped with a NS polarized magnet 15 is provided inside the stator 14. The rotor 16 is rotatably born by a bearing 17, and rotated by the NS magnetization of the stator 14. A screw portion 16a is formed inside the rotor 16.

A shaft (output shaft) 18 having a screw portion 18a to be screwed with the screw portion 16a of the rotor 16 is provided inside the rotor 16, and the torque produced by the rotor 16 is transmitted thereto. The portion of the shaft 18 to be inserted into a rectangular sliding portion 19a formed in a boss 19 is formed in the shape of a plate, and converts the transmitted torque into translatory force at the sliding portion 19a to be translatorily driven. Also, a screw portion 18b is formed at the tip portion of the shaft 18.

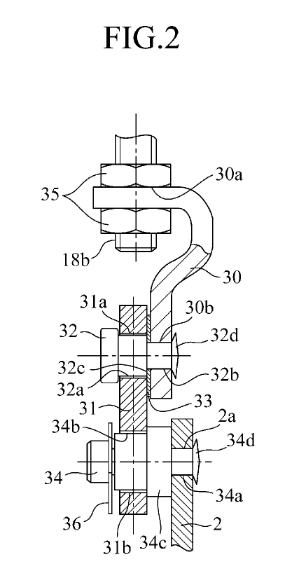

Next, the connecting structure 3 constructed above that connects the shaft 18 of the actuator 1 and a lever 2 to each other will next be discussed with reference to FIGS. 1 and 2. The connecting structure 3 is composed of a joint 30, a link plate 31, a joint pin (pin) 32, a washer 33, and a lever pin 34.

The joint 30 is a plate-shaped member formed in a substantially L-shaped one as shown in FIG. 2, a hole 30a for passing through the shaft 18 is formed in the substantial L-shaped portion, while a hole 30b for passing through the joint pin 32 is formed at the other end thereof. When the screw portion 18b at the tip of the shaft 18 is passed through the hole 30a, the joint 30 is fixed with nuts 35 fitted to the screw portion 18b.

The link plate 31 connects the joint 30 fixed to the shaft 18 and the lever 2 to each other to thereby function as a linkage mechanism. A hole 31a for passing through a joint pin 32 is formed at one end of the link plate 31, while a hole 31b for passing through the lever pin 34 is formed at the other end thereof.

The joint pin 32 is provided for connecting the joint 30 and the link plate 31 to each other with the washer 33 interposed therebetween. In the joint pin 32, a link plate fitting portion 32a to be fitted with the hole 31a of the link plate 31 is formed on the distal side thereof, while a joint fitting portion 32b to be fitted with the hole 30b of the joint 30 is formed on the proximal side thereof. Note that the joint pin 32 has a shoulder 32c adapted such that the diameter of the link plate fitting portion 32a is formed larger than that of the joint fitting portion 32b. Further, the link plate fitting portion 32a is formed to have a thickness larger than that of the link plate 31, and also have a diameter smaller than that of the hole 31a of the link plate 31, thus enabling the link plate 31 to be freely rotated when a tip portion 32d of the joint pin 32 is riveted to connect the joint 30 and the link plate 31 to each other. The joint pin 32 is fitted with the link plate 31, washer 33, and joint 30 in the order, and fixed by riveting of the tip portion 32d of the joint pin 32 passed through the hole 30b of the joint 30.

The washer 33 is disposed between the joint 30 and link plate 31, and prevents the joint 30 and link plate 31 from coming in face-to-face contact with each other to thereby prevent the joint 30 from being worn by the sliding of the link plate 31. The washer 33 is formed by a hardened stainless material (H-material). Moreover, when the tip portion 32d of the joint pin 32 is riveted on the side of the joint 30, the washer 33 is pressed against the side of the joint 30 by the shoulder 32c of the joint pin 32 to be fixed thereto without wobbling.

The lever pin 34 is provided for connecting the lever 2 and the link plate 31 to each other. A lever fitting portion 34a to be fitted with a hole 2a formed at the end portion of the lever 2 is formed at one end side of the lever pin 34, while a link plate fitting portion 34b to be fitted with the hole 31b of the link plate 31 is formed at the other end side thereof. Note that a large thickness portion 34c between the lever fitting portion 34a and the link plate fitting portion 34b prevents the lever 2 and link plate 31 from coming in face-to-face contact with each other to thereby prevent the lever 2 from being worn by the sliding of the link plate 31.

The lever pin 34 is first fixed to the lever by passing the lever fitting portion 34a through the hole 2a of the lever 2 and then riveting the tip portion 34d thereof. The link plate fitting portion 34b is then passed through the hole 31b of the link plate 31, and thereafter a retaining ring 36 for preventing the disconnection of the link plate 31 is fitted thereto.

Next, the assembly of the connecting structure 3 as constructed above will be described.

The screw portion 18b of the shaft 18 of the actuator 1 is first passed through the hole 30a of the joint 30, and the joint 30 is fixed to the shaft 18 by the nuts 35 screwed with the screw portion 18b of the shaft 18. Then, the joint pin 32 is passed through the hole 31a of the link plate 31, and then the washer 33 is fitted to the passed-through portion thereof.

Then, the joint pin 32 to which the link plate 31 and washer 33 are fitted is passed through the hole 30b of the joint 30 and fixed by riveting the tip portion 32d of the joint pin 32 that projects on the surface of the joint 30. At that time, the washer 33 disposed between the link plate 31 and the joint 30 is pressed against the side of the joint 30 by the shoulder 32c of the joint pin 32, and fixed without wobbling.

On the other hand, the lever fitting portion 34a of the lever pin 34 is passed through the hole 2a of the lever 2, and the tip portion 34d projecting on the surface of the lever pin 34 is riveted and fixed. Then, the link plate fitting portion 34b of the lever pin 34 fitted with the lever 2 is passed through the hole 31b of the link plate 31, and further the retaining ring 36 is fitted to a projecting portion that projects on the surface of the link plate 31, thus connecting the joint 30 and the lever 2 to each other through the link plate 31.

With such a connection, as shown in FIG. 1, when the shaft 18 of the actuator 1 is driven in translation, the lever 2 can be driven in an arc about a supporting shaft 0 through the joint 30 and link plate 31.

As discussed above, according to the first embodiment of the present invention, when the joint 30 fixed to the shaft 18, and the link plate 31 are connected to each other, without using the retaining ring, the joint pin 32 which is passed through the hole 31a of the link plate 31 and with which the washer 33 is fitted is passed through the hole 30b of the joint 30 to be fixed by riveting the tip portion 32d of the joint pin 32 projecting on the surface of the joint 30. As a result, there no arise the deformation and breakage of a retaining ring caused by the load applied to the retaining ring used in a conventional connecting structure, wear thereof, and so on; thus, the durability of the sliding portion of the connecting structure 3 can be enhanced. Furthermore, when the number of the retaining rings is reduced, the number of the components thereof can be reduced.

Moreover, through the use of the link plate 31 connected to the joint 30 fixed to the shaft 18, the connection to the lever pin 34 fixed to the lever 2 is carried out, which can make easily the assembly work of the connecting structure 3.

Further, when the joint pin 32 fitted with the link plate 31 is fitted by riveting on the side of the joint 30, the joint fitting portion 32b of the joint pin 32 should have a diameter smaller than that of the link plate fitting portion 32a, and thus the large thickness portion 34c like the lever pin 34 cannot be provided. Under such a condition, if the connection between the joint 30 and the link plate 31 is carried out, the joint 30 comes in face-to-face contact with the link plate 31, resulting in the wear on the joint 30 because of the sliding of the link plate 31. In this case, it is necessary that the joint 30 be subjected to surface treatment to increase the wear resistance to the sliding of the link plate 31; however, the surface treatment must extend to the whole joint 30, and thus in the case where a large-sized joint 30 is required, processing cost and time for the surface treatment increase.

However, in the connecting structure 3 of the first embodiment in the invention, since it is configured such that the washer 33 is disposed between the joint 30 and the link plate 31, the joint 30 and the link plate 31 come in no face-to-face contact with each other; thus, the joint 30 can be prevented from being worn down by the sliding of the link plate 31.

Further, when the tip portion 32d of the joint pin 32 is fixed by riveting on the side of the joint 30, the fixation is performed without wobbling when the washer 33 is pressed against the side of the joint 30 by the shoulder 32c of the joint pin 32; thus, the washer 33 is prevented from being wobbled by the vibration of the actuator 1, further enhancing the wear resistance thereof.

Moreover, since the washer 33 is constituted by a hardened stainless material (H-material), the washer 33 does not need to be subjected to the surface treatment, which can reduce the processing cost and save a labor for making the surface treatment.

Incidentally, in the connecting structure 3 of the first embodiment in the invention, it is configured as follows: in the joint 30 fixed to the shaft 18, the joint pin 32 passing through the hole 31a of the link plate 31 and fitted with the washer 33 is passed through the hole 30b of the joint 30; and the tip portion 32d of the joint pin 32 projecting on the surface of the joint 30 is fixed by riveting. However, it may be configured as follows: in the lever 2, the lever pin passing through the hole 31b of the link plate 31 and fitted with the washer 33 is passed through the hole 2a of the lever 2; and the tip portion of the lever pin projecting on the surface of the lever 2 is fixed by riveting. For the lever pin in this case, the link plate fitting portion is formed on the proximal side of the pin, and the lever fitting portion is formed on the distal side thereof, and further the pin has a shoulder adapted such that the diameter of the link plate fitting portion is formed larger than that of the lever fitting portion.

Note that the connecting structure 3 of the first embodiment in the invention is discussed using an electric actuator 1; however, the actuator is not limited thereto, and the connecting structure 3 of the invention may be applied to another type of actuator, for example, a hydraulic type of actuator.

### INDUSTRIAL APPLICABILITY

According to the connecting structure of the present invention, the number of the retaining rings used for the conventional connecting structure can be reduced; thus, the durability of the sliding portion of the connecting structure can be enhanced, and the assembly of the connecting structure can be easily carried out. Therefore, the connecting structure is suitable for use in, for example, a connecting structure where a joint fixed to an output shaft of an actuator and a lever on the part serving as an object to be actuated are connected to each other through a link plate.

1. A connecting structure where a joint fixed to an output shaft of an actuator and a lever on the part serving as an object to be actuated are connected to each other through a link plate, the connecting structure comprising:
a pin which has a shoulder adapted such that the diameter of a portion to be fitted to the link plate is formed larger than that of a portion to be fitted to the joint or lever, and of which the tip portion passing through a hole of the joint or lever is fixed by riveting;
and a washer that is disposed between the joint or lever fitted with the pin, and the link plate, and that is pressed and fixed against the joint or lever by the shoulder of the pin when the tip portion of the pin is riveted.

2. The connecting structure according to claim 1, wherein the washer is formed by a hardened material.
